(19) United States
(12) Patent Application Publication
(10) Pub. No.: US 2023/0203726 A1
(43) Pub. Date: Jun. 29, 2023

(54) DEVICE FOR DRAWING FILAMENTS TO FORM A NONWOVEN FABRIC

(71) Applicant: Oerlikon Textile GmbH & Co. KG, Remscheid (DE)

(72) Inventors: Shigang Li, Beijing (CN); Ye Zhonghui, Beijing (CN)

(21) Appl. No.: 18/086,963

(22) Filed: Dec. 22, 2022

(30) Foreign Application Priority Data
Dec. 23, 2021 (CN) 202111590095.3

(51) Int. Cl. D04H 3/04

(52) U.S. Cl. CPC D04H 3/04

(57) ABSTRACT

A device draws filaments to form a nonwoven fabric. The device has a nozzle carrier, the nozzle carrier having an elongated drawing channel, wherein the drawing channel comprises a filament inlet and a filament outlet, the drawing channel being provided on opposite sides with air nozzles generating a downward air flow, the air nozzles being connected to an air chamber on both sides of the nozzle carrier through an air channel, a rectification device being provided between the air channel and the air chamber, the rectification device having at least one rectification chamber, a rectification wall of the at least one rectification chamber being provided to be partially ventilated. The air flow is temporarily confined in a small space by the space restriction of the rectification chamber, and as air flows, the air flows out of the partially ventilated area, which acts as a “combing” of the air flow.

### TECHNICAL FIELD

The present invention relates to a device for drawing filaments to form a nonwoven fabric.

### BACKGROUND ART

In production of nonwovens, a plurality of extruded filaments must be deposited as uniformly as possible to form a lamellar structure. After extrusion and cooling, the filaments are drawn by a process air stream and guided into a web-forming belt. For example, a generic device is described in U.S. Pat. No. 6,183,684.

In the known device, a nozzle carrier with a nozzle is used to draw out the synthetic filament from the spinning unit after extrusion, which is later to be drawn and deposited. For this purpose, the nozzle carrier has a drawing channel with a funnel-shaped filament inlet on upper side and a slotted filament outlet on lower side. A short distance below the filament inlet, there are opposing longitudinal slits which are connected to the drawing channel via an air inlet for the supply of process air. The process air enters the drawing channel at overpressure so that the filaments are drawn in through the filament inlet, accelerated in the drawing channel and blown out through the filament outlet. The filaments are deposited on the web-forming belt, forming a web.

For this purpose, it is necessary to make the air flow of the process air as uniform as possible over the entire width of the guiding channel. Disturbances in the air flow are immediately noticed during the deposition of the filaments and thus directly affect evenness of web laid.

### SUMMARY OF THE INVENTION

It is an object of the present invention to improve the existent device for drawing filament to form nonwoven fabrics with the aim that process air can be uniformly supplied to the guiding channel.

According to a first technical solution of the present invention, a device for drawing filaments to form a nonwoven fabric, having a nozzle carrier, the nozzle carrier having an elongated drawing channel, wherein the drawing channel comprises a filament inlet and a filament outlet, wherein the drawing channel has on its opposite sides an air nozzle generating a downward air flow, wherein the air nozzle communicates with an air chamber on both sides of the nozzle carrier through an air channel, wherein, a rectification device is provided between the air channel and the air chamber; air flow passes from the air chamber through the rectification device and enters the air channel through the air channel inlet; the rectification device has at least one rectification chamber; a rectification wall of the at least one rectification chamber is provided to be partially ventilated.

The rectification wall of the at least one rectification chamber is set to be partially ventilated, the effect of which is to temporarily consolidate the airflow in a small space through the space restriction of the rectification chamber, and as the airflow flows, the airflow exits from the partially ventilated area. This process acts like a “combing” of the airflow.

According to the second technical solution of the present invention, the ventilated area of at least one of the rectifying walls is staggered with the ventilated area of the other rectifying wall.

This staggering arrangement avoids that the turbulent airflow passes directly through the rectifying device directly into the drawing channel. Thus, the staggered setting enhances rectification effect.

In the case where the rectification device has only one rectification chamber, according to the third technical solution of the present invention, the rectification chamber is provided with a ventilated area in a first position of the rectification wall thereof away from the air chamber corresponding to an air channel inlet; the rectification chamber has an air inlet at a position staggered from the first position of the rectification wall near the air chamber.

In the case where the rectification device has two rectification chambers, according to a fourth technical solution of the present invention, in the rectification chamber away from the air chamber, its rectification wall close to the air channel has an ventilated area in a first position corresponding to the air channel inlet; the rectification wall between the two rectification chambers is provided with a ventilated area at a second position staggered from the first position; in the rectification chamber closest to the air chamber, its rectification wall close to the air chamber has an air inlet at a third position corresponding to the second position of the rectification wall.

According to a fifth technical solution of the present invention, the rectification chamber is further provided with a honeycomb plate between the rectification chamber and the air channel. The honeycomb plate is able to further rectify the air flow.

According to a sixth technical solution of the present invention, the honeycomb plate has a ventilated area close to the area of the air channel inlet.

According to a seventh technical solution of the present invention, the air chambers are plural and placed side by side; each the air chambers is connected to the air duct through a connecting tube.

According to an eighth technical solution of the present invention, the air chamber is provided with a deflector between an inlet port and an outlet port.

According to a ninth technical solution of the present invention, the deflector has its first end fixed to a first side wall of the air chamber near the rectification chamber and extends in a horizontal direction, a second end of the deflector is spaced from a second side wall of the air chamber opposite to the first side wall.

After the process air enters into the air chamber from the inlet end, it is guided to flow along the surface of the deflector, creating a deflection of the air stream within the common confines of the air chamber and the deflector.

### DESCRIPTION OF THE DRAWINGS

FIG. 1 is a schematic structural diagram of a device for drawing filaments to form a nonwoven fabric of the present invention.

FIG. 2 shows a schematic structural diagram of a rectification device under the embodiment shown in FIG. 1.

FIG. 3 shows a partial three-dimensional view of a rectification device under the embodiment shown in FIG. 1.

FIG. 4 shows a partial three-dimensional view of another embodiment of a rectification device.

### DETAILED DESCRIPTION

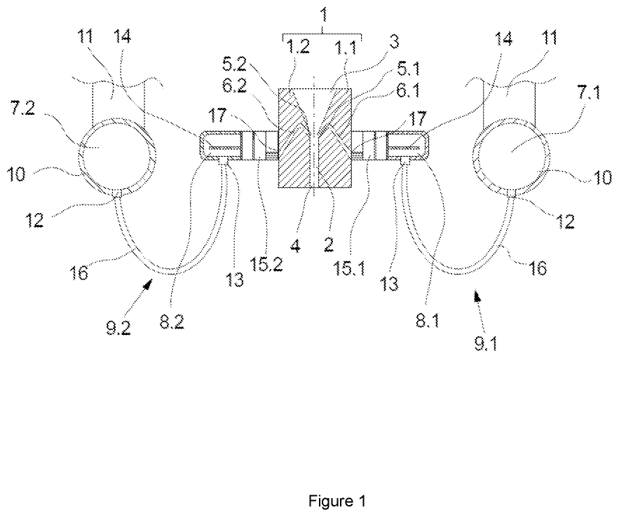

FIG. 1 schematically illustrates a device for drawing filaments to form a nonwoven fabric according to the present invention. FIG. 1 shows a cross-sectional view. This embodiment has an elongated nozzle carrier 1. The nozzle carrier 1 comprises two longitudinal beams 1.1 and 1.2. The longitudinal beams 1.1 and 1.2 form a drawing channel 2 between them. The drawing channel 2 has a filament inlet 3 on upper side of the nozzle carrier 1, which is V-shaped. On lower side of the nozzle carrier 1, a filament outlet 4 is formed between longitudinal beams 1.1 and 1.2, which is in the shape of narrow slit.

The nozzle carrier 1 is fixed in a machine frame not shown here and can be adjusted in the machine frame at a height above a web-forming belt. For example, the height of the nozzle carrier 1 relative to the web-forming belt is usually adjusted at the beginning of process.

The structure of the longitudinal beams 1.1 and 1.2 is substantially mirror-symmetrical. Each of the longitudinal beams 1.1 and 1.2 can be made in several parts in order to form the channels and openings required for air guidance. Thus, each longitudinal beam 1.1 and 1.2 has an air channel 6.1 and 6.2 which leads to the drawing channel 2. The air channels 6.1 and 6.2 each have an air channel inlet 17.

The rectification devices 15.1 and 15.2 are provided on the longitudinal beams 1.1 and 1.2 of the nozzle carrier 1. The rectification device 15.1 is connected both to the air chamber 8.1 and to the air channel 6.1. Thus, the rectification device 15.2 is arranged between the air chamber 8.2 and the air channel 6.2. The rectification device is used to adjust the turbulent air flow in order to create a gentle and consistent air flow.

As can be seen from FIG. 1, each of the air chambers 8.1, 8.2 is connected to the air channels 6.1, 6.2 through the air channel inlet 17. At the bottom of the air chamber 8.1, an inlet end 13 is formed, to which a connecting tube 9.1 is connected. Inside the air chamber 8.1, a deflector 14 is provided between the inlet end 13 and the outlet end of the air chamber 8.1. In this embodiment, the deflector 14 is arranged directly above the inlet end 13. The deflector 14 creates a deflection of the supplied process air in the air chamber 8.1 in order to obtain a uniform distribution of the process air. The air chambers 8.1 are provided in a plurality along the width direction (perpendicular to the paper surface) and placed side by side.

As can be seen in FIG. 1, there is an air duct 7.1 and 7.2 on each of the two longitudinal sides of the nozzle carrier 1. The air ducts 7.1 and 7.2 are formed by ducts 10, each connected to a holder 11. An outlet connection 12 is provided at the bottom of the duct 10. In each case, one of the outlet connections 12, for example on the connection pipe 9.1, is connected to the inlet end 13 on the air chamber 8.1 forming a connecting surface. Each of the connecting tubes 9.1 and 9.2 comprises a flexible hose 16. The flexible connection of the air chambers 8.1, 8.2 to the air ducts 7.1 and 7.2 allows the nozzle carrier 1 to move relative to the fixed air ducts 7.1 and 7.2.

The air chamber 8.2 in the longitudinal direction of the longitudinal beam 1.2 and the connection manner of the air chamber 8.2 with the connecting tube 9.2 and the air duct 7.2 are identical and mirror-symmetrical.

Thus, the process air (not shown here) for drawing the filament can be introduced on both sides of the drawing channel 2 through air nozzles 5.1 and 5.2 with the direction of airflow down the drawing channel 2. The air nozzle is preferably configured as a slit with a gap distance of 0.5-1.3 mm. The air ducts 7.1 and 7.2 are connected to a compressed air source not shown here. The process air is supplied from the air ducts 7.1 and 7.2 at an overpressure of 0.5 to 5 bar, preferably in the overpressure range of 1 to 3 bar.

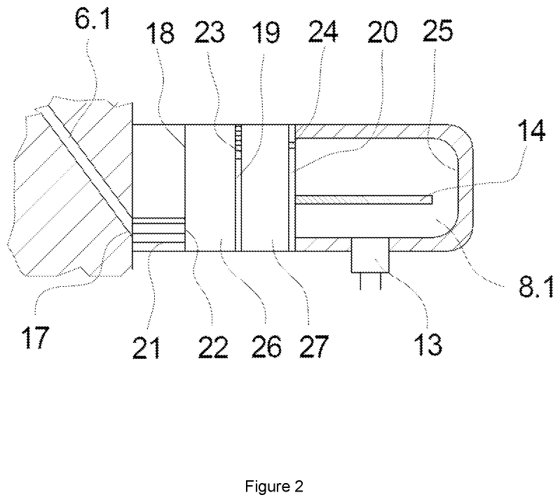

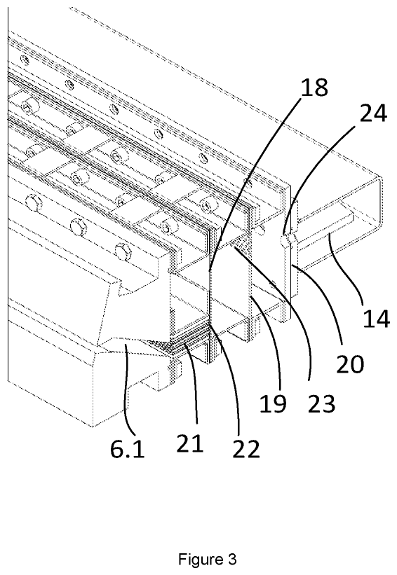

FIG. 2 shows a schematic diagram of the structure of a rectification device of a device for drawing filaments to form a nonwoven fabric according to the present invention. FIG. 3 shows a partial three-dimensional view of the rectification device under the embodiment of FIG. 2. The rectification device 15.1 will be described in connection with FIG. 2 and FIG. 3. The rectification devices 15.1 and 15.2 have the same structure and are mirror-symmetrical in FIG. 1, so that only one rectification device is described here.

As shown in FIG. 2, the rectification device has two rectification chambers 26, 27 provided adjacent to each other. The air chamber 8.1 is adjacent to the rectification chamber 27. In the air chamber 8.1, one end of the deflector 14 is fixed to a side wall 20 of the air chamber 8.1 near the rectification chamber 27, the deflector 14 extending in a horizontal direction and its other end being spaced from a side wall 25 of the air chamber 8.1 opposite the side wall 20. A air inlet is provided in a third position 24 of the side wall 20, the third position 24 being in the upper part of the side wall 20. Thus, after entering the air chamber 8.1 from the inlet end 13, the process air is guided to flow along the surface of the deflector 14, creating a deflection of the air stream within the common confines of the air chamber 8.1 and the deflector 14. The process air is guided at a substantially horizontal direction before entering the air inlet.

The rectification wall 19 of the rectification chamber 27 is provided with a second position 23 corresponding to the third position 24, the third position 24 being opposite to the second position 23. The second position 23 is constituted as a ventilated area and the other positions of the rectification wall 19 are constituted as non-ventilated areas. The rectification wall 18 of the rectification chamber 26 is provided with a first position 22 staggered from the second position 23, again the first position 22 being constituted as ventilated and the first position 22 being in this embodiment located in the lower part of the rectification wall 18. A honeycomb plate 21 is mounted between the rectification chamber 26 and the air channel 6.1. The honeycomb plate 21 is likewise ventilated and has a ventilated area close to the area of the air channel inlet 17. The rectification device forces the process air flow to be adjusted in the rectification chamber by staggered setting of the ventilated positions, so that the process air flow is not a turbulent flow when entering the air channel inlet 17.

It is obtainable out of above mentioned description that rectifying walls of the rectifying chambers 26, 27 are in each case partially ventilated.

During the filament drawing process, the filament is continuously drawn into the drawing channel 2 through the filament inlet 3. Within the drawing channel 2, the filament is drawn by the process air and blown out together as a fiber stream through the filament outlet 4.

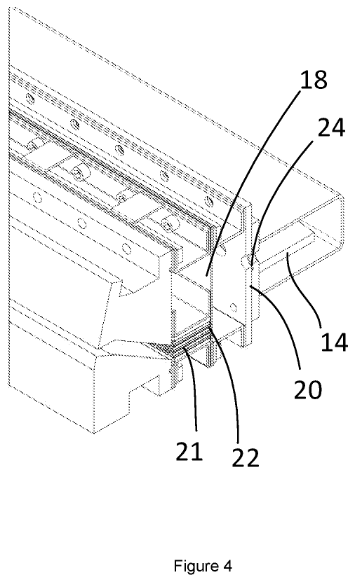

FIG. 4 shows a partial three-dimensional view of another embodiment of the rectification device. The difference from the previous embodiment is that the rectification chamber of the rectification device is one. The rectification chamber is provided with a ventilated area at a first position 22 of the rectification wall 18 away from the air chamber, corresponding to the air channel inlet, the first position 22 being located in the upper part of the rectification wall 18. The rectification chamber has an air inlet at a position 24 staggered from the first position 22 of the rectification wall 19 near the air chamber. Due to the staggered position, the process air flow, after entering the air inlet, is forced to be adjusted and becomes mild and orderly, and afterwards flows out of the honeycomb plate 21.

1. A device for drawing filaments to form a nonwoven fabric, comprising:
a nozzle carrier having an elongated drawing channel, wherein the drawing channel comprises a filament inlet and a filament outlet, wherein the drawing channel has on its opposite sides an air nozzle generating a downward air flow, and wherein the air nozzle communicates with an air chamber on both sides of the nozzle carrier through an air channel, and
a rectification device provided between the air channel and the air chamber;
wherein air flow passes from the air chamber through the rectification device and enters the air channel through the air channel inlet;
wherein the rectification device has at least one rectification chamber; and
wherein a rectification wall of the at least one rectification chamber is provided to be partially ventilated.

2. The device as claimed in claim 1, wherein the ventilated area of at least one of the rectification walls is provided staggered from the ventilated area of another rectification wall.

3. The device as claimed in claim 2,
wherein the rectification device has one rectification chamber;
wherein the rectification chamber is provided with a ventilated area in a first position of the rectification wall thereof away from the air chamber corresponding to an air channel inlet; and
wherein the rectification chamber has an air inlet at a position staggered from the first position of the rectification wall near the air chamber.

4. The device as claimed in claim 2,
wherein the rectification device has two rectification chambers;
wherein in the rectification chamber away from the air chamber, its rectification wall close to the air channel has an ventilated area in a first position corresponding to the air channel inlet;
wherein the rectification wall between the two rectification chambers is provided with a ventilated area at a second position staggered from the first position; and
wherein in the rectification chamber closest to the air chamber, its rectification wall close to the air chamber has an air inlet at a third position corresponding to the second position of the rectification wall.

5. The device as claimed in claim 4, wherein the rectification chamber is further provided with a honeycomb plate between the rectification chamber and the air channel.

6. The device as claimed in claim 5, wherein the honeycomb plate has a ventilation area with a size close to the area of the air channel inlet.

7. The device as claimed in claim 6, wherein the air chambers are plural and are placed side by side, and each of the air chambers is connected to an air duct through a connecting tube.

8. The device as claimed in claim 7, wherein the air chamber is provided with a deflector between an inlet port and an outlet port.

9. The device as claimed in claim 8, wherein the deflector has its first end fixed to a first side wall of the air chamber near the rectification chamber and extends in a horizontal direction, and a second end of the deflector is spaced from a second side wall of the air chamber opposite to the first side wall.
